(19) United States
(12) Patent Application Publication
(10) Pub. No.: US 2024/0246202 A1
(43) Pub. Date: Jul. 25, 2024

(54) Method for Operating a Hand-Held Power Tool

(71) Applicant: Robert Bosch GmbH, Stuttgart (DE)

(72) Inventors: Jasmin Giessler, Steinach (DE); Christoph Steurer, Urbach (DE); Marcus Schuller, Dettenhausen (DE); Stefan Mock, Remshalden (DE); Simon Erbele, Nufringen (DE); Wolfgang Herberger, Stuttgart (DE)

(21) Appl. No.: 18/412,544

(22) Filed: Jan. 14, 2024

(30) Foreign Application Priority Data
Jan. 24, 2023 (DE) 10 2023 200 523.9

(51) Int. Cl. B25B 21/02; B25F 5/00

(52) U.S. Cl. CPC B25B 21/02; B25F 5/00

(57) ABSTRACT

A method for operating a hand-held power tool, in particular a rotary impact wrench, the hand-held power tool comprising a tool holder for receiving a tool such as a tool bit or a nut, wherein the tool is configured to rotatably drive the fastening element via a corresponding drive of a fastening element, includes screwing the fastening element into a substrate while rotating the tool holder, and thus the fastening element, in a first direction of rotation, and rotating the tool holder in a second direction of rotation opposite the first direction of rotation at a predefined speed and for a predefined time period.

This application claims priority under 35 U.S.C. § 119 to application no. DE 10 2023 200 523.9, filed on Jan. 24, 2023 in Germany, the disclosure of which is incorporated herein by reference in its entirety.

The disclosure relates to a method for operating a hand-held power tool, preferably a rotary impact wrench, a computer program for performing the method and a hand-held power tool set up for performing the method.

### BACKGROUND

Known from the prior art (see, e.g., EP 3 381 615 A1) are hand-held power tools for tightening and loosening screw elements, e.g. threaded nuts and screws designed as rotary impact wrenches. Rotary impact wrenches comprise a structure in which an impact force in a rotational direction is transferred to a screw element by a rotational impact force of a hammer. A rotary impact wrench with this design comprises a motor, a hammer intended to be driven by the motor, an anvil that is struck by the hammer, and a tool. Regarding the rotary impact wrench, the motor installed in a housing is driven, whereby the hammer is driven by the motor, the anvil is struck by the rotating hammer in turn, and a percussive force is delivered to the tool, whereby two different operating states, i.e., “no percussive operation” and “percussive operation,” can be distinguished.

Rotary impact wrenches are typically used with interchangeable nuts for hex heads or tool bits. A problem can arise if the nut or the bit gets jammed on or in the drive of the fastening element or on the interface of the device for holding the accessories, e.g. nuts or bits, when tightening or screwing a fastening element. In the scope of the present disclosure, the term “jam” or also “jamming” is used in this context. In some cases, jamming cannot be released even with considerable force. This problem is quite common due to the high torques usually needed to tighten a screw connection and the pulse-like load from the impact operation in the case of rotary impact wrenches.

Although the disclosure is described in the present disclosure primarily on the basis of a rotary impact wrench, it is not limited to this application, but may also be applied to other hand-held power tools comprising a rotary drive, e.g. cordless screwdrivers.

### SUMMARY

The object of the disclosure is to provide a method for operating a hand-held power tool which improves upon the prior art and at least partly overcomes the aforementioned disadvantages, or at least is an alternative to the prior art. A further object is to specify a corresponding hand-held power tool.

Said objects are achieved by means of the respective subject matter of the disclosure. Advantageous embodiments of the disclosure are the subject matter of the disclosure.

Disclosed according to the disclosure is a method for operating a hand-held power tool, the hand-held power tool comprising a tool holder for receiving a tool, e.g. a tool bit or a nut. The tool is configured to rotatably drive the fastening element via a corresponding drive of a fastening element. This method comprises the following steps:
S1 screwing the fastening element in a substrate, rotating the tool holder and thus the fastening element in a first direction of rotation;
S2 rotating the tool holder in a second direction of rotation opposite the first direction of rotation, at a predefined speed, and for a predefined time period.

The rotation in the first direction of rotation as defined in step S1 in the context of the present description is to be understood as a rotation in the direction that causes the fastening element to be screwed. For fastening elements with a right-hand thread, this means a clockwise rotation; for fastening elements with a left-hand thread, this means a counterclockwise rotation.

After the screwing process, the fastening element is held in the screwed state with a particular release torque. Rotating the tool holder in the second direction of rotation opposite to the first direction of rotation thus causes a torque to act in the interfaces between the fastening element, tool and tool holder, which corresponds at least to the release torque and is thus large enough to release a jam that has potentially occurred at one or more of these locations during screwing. By selecting the appropriate speed and/or time period of rotation in the second direction of rotation, the screw connection is not loosened or is only loosened to a negligible extent.

Renewed jamming during rotation in the second direction of rotation does not usually occur due to the low energy introduced.

In this way, when screwing a fastening element with a rotary impact wrench, jamming of the drive and the fastening element or the drive and interface of the device can be reliably released.

So, a user does not need to remove the screw or nut from the nut or bit themselves, with or without additional tools such as pliers, or loosen the nut or bit from the device. Accordingly, the risk of injury is reduced when jamming is manually released.

Furthermore, the speed of releasing serial screwing operations is increased and the process is simplified by eliminating the need for an additional tool.

In embodiments, the method comprises the following step:
S1a monitoring whether jamming has occurred during or after screwing, whereby jamming occurs when the tool is jammed in the tool holder and/or when the drive of the fastening element and the tool are jammed in each other.

In this case, the monitoring in step S1a may be performed by a user of the hand-held power tool or may be performed at least partially automatically.

The at least partially automatic monitoring of whether jamming has occurred can be performed, for example, by using measured variables from the hand-held power tool, comprising measured variables, e.g. acceleration data recorded by sensors installed specifically for this purpose.

In embodiments, step S2 is initiated by the user actuating a control button separate from an on/off switch of the hand-held power tool.

In embodiments, step S2 is performed when it is determined in step S1a that jamming has occurred. The screw parameters used in step S2 such as rotational speed, duration of the direction of rotation reversal, and/or the level of the applied torque can be adjusted to the current screw connection.

The screwing in step S1 can be performed at least partially using a rotary impact operation. Rotary impact operation is understood to be an operation in which an impact mechanism of the hand-held power tool exerts pulse-like impacts on the fastening element to be screwed in its direction of rotation. The rotary impact operation is typically performed when using rotary impact wrenches.

In embodiments, the method comprises the following step:
S3 automatically detecting the rotary impact operation.

Step S2 can be performed after a predefined time period after detecting the rotary impact operation and/or after a predefined number of impacts of the rotary impact operation.

In embodiments of the disclosure, the automatic detection in step S3 is performed at least partially using a signal waveform of an operating variable of an electric motor of the hand-held power tool. Such a signal waveform can, e.g., reflect the motor current.

The method can therefore be performed completely automatically, with the resulting advantages in terms of the simplest possible handling of the hand-held power tool by a user.

In embodiments, actuating an operation button of the hand-held power tool triggers step S1, and releasing the operation button cancels and/or ends the method.

In this case, the user is free to independently react to any jamming which may possibly also be detected by the user.

In some embodiments, the method is started or initialized via a software application (app), in which case the app is executed on a terminal device separate from the hand-held power tool.

In addition to ease of operation by the user, this has, among other things, advantages with respect to an efficient adjustment of the parameters of the screwing operation and thus with respect to an efficient operation of the hand-held power tool.

In some embodiments, parameters of the screwing operation are adjustable via the app, whereby the parameters comprise one or a plurality of the following parameters:
diameter and/or type of fastening element;
material, strength, and/or hardness of the substrate;
predefined speed and/or predefined time duration of step S2.

In some embodiments, the method is started or initialized by actuating an operation button located on the hand-held power tool.

In some embodiments, the predefined speed and the predefined time period is predefined in step S2 such that a jamming of the tool in the tool holder and/or the drive of the fastening element with the tool is released, but without the screw connection being loosened.

In some embodiments, the rotation is performed in the first or second direction of rotation in steps S1 and/or S2 while passing through a run-up ramp. A rotational speed of the tool holder is increased from a very small value to the desired rotational speed, e.g. continuously over a predefined time period or with a predefined slope. This is advantageous because sudden changes in the acceleration state of the tool holder, which in turn may be associated with jamming, are avoided.

A further object of the disclosure forms a computer program for performing the method described hereinabove when the computer program is executed by a controller of the hand-held power tool.

A further object of the disclosure is a hand-held power tool comprising an electric motor, a tool holder rotationally driven by the electric motor for receiving a tool, and a controller for controlling the electric motor. The controller is in this case configured to perform the method described hereinabove.

In the context of the present disclosure, the term “ascertaining” is meant to include in particular measuring or receiving, whereby “receiving” is understood in the sense of measuring and storing, and “ascertaining” also includes possible signal processing of a measured signal.

Furthermore, the term “deciding” should also be understood as recognizing or detecting, whereby a clear allocation is to be achieved. The term “identifying” is understood to mean a detection of a partial match with a pattern, which can, e.g., be enabled by fitting a signal to the pattern, a Fourier analysis, or the like. The term “partial match” is understood to mean that the fitting has an error that is less than a specified threshold value, in particular less than 30%, quite in particular less than 20%.

The signal of the operating variable is in this context considered to mean a chronological sequence of measured values. Alternatively and/or additionally, the signal of the operating variable can also be a frequency spectrum. Alternatively and/or additionally, the signal of the operating variable can also be reworked, for example smoothed, filtered, fitted, and the like.

Further features, possible applications, and advantages of the disclosure emerge from the following description of the exemplary embodiment of the disclosure, which is shown in the drawing. It should be noted that the features described or depicted in the drawings themselves or in any combination thereof describe the subject matter of the disclosure irrespective of their summary in the disclosure or their reverse relationship, as well as irrespective of their wording or illustration in the specification or drawing and have only a descriptive character and are not intended to restrict the disclosure in any way.

### BRIEF DESCRIPTION OF THE DRAWINGS

The disclosure will be explained in further detail hereinafter with reference to the drawings. Shown are:

FIG. 1 a schematic illustration of an electric hand-held power tool;

FIG. 2 a flowchart of an exemplary embodiment of the method according to the disclosure;

FIG. 3 a flowchart of an exemplary embodiment of the method according to the disclosure;

FIG. 4 a flowchart of an exemplary embodiment of the method according to the disclosure;

FIG. 5 a flowchart of an exemplary embodiment of the method according to the disclosure;

FIG. 6 a flowchart of an exemplary embodiment of the method according to the disclosure;

FIG. 7 a schematic representation of a signal of an operating variable of a hand-held power tool; and

FIG. 8 a schematic illustration of two different recordings of the signal of the operating variable.

### DETAILED DESCRIPTION

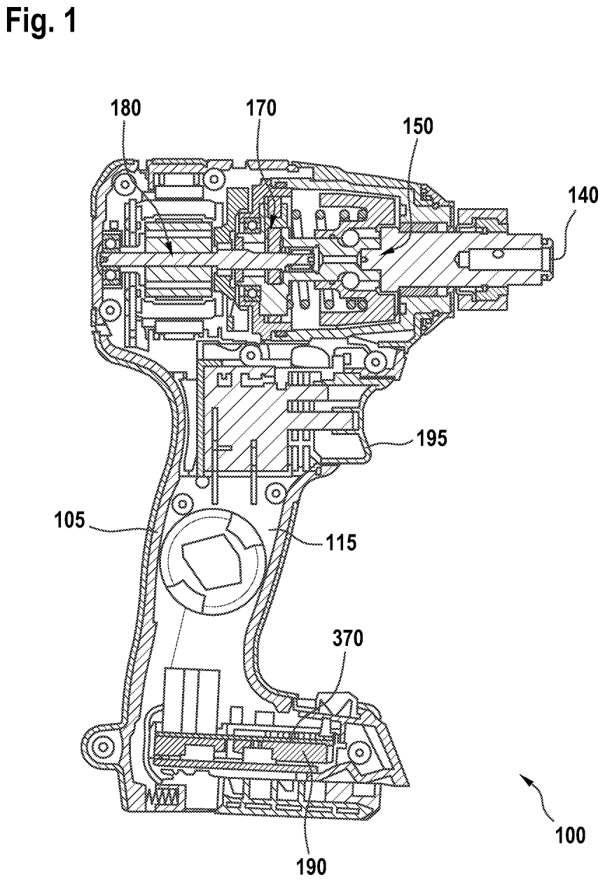

FIG. 1 shows a hand-held power tool 100 having a housing 105 with a handle 115. According to the embodiment shown, the hand-held power tool 100 is mechanically and electrically connectable to a battery pack 190 for off-grid power supply.

A powered electric motor 180 and a transmission 170 from the battery pack 190 are arranged within the housing 105. The electric motor 180 is connected to an input spindle via the transmission 170. Furthermore, a controller 370 is arranged within the housing 105 in the region of the battery pack 190, which influences the electric motor 180 and the transmission 170 by means of, for example, a set motor speed n, a selected rotational pulse, a desired transmission gear x, or the like.

For example, the electric motor 180 is actuatable, i.e., switchable, via a hand switch or actuating switch 195, and can be any type of motor, for example, an electronically commutated motor or a DC motor. In principle, the electric motor 180 is electronically controllable or adjustable such that both a reversing operation and specifications regarding the desired motor speed n and the desired rotational pulse can be implemented. The functionality and construction of a suitable electric motor are sufficiently known from the prior art, so that a detailed description is omitted here for the purpose of shortening the description.

A tool holder 140 is rotatably supported in the housing 105 via an input spindle and an output spindle. The tool holder 140 serves to receive a tool and can be directly formed on the output spindle and connected thereto in a cap-like manner.

The controller 370 is in communication with a power source and is designed so as to electronically controllably or adjustably drive the electric motor 180 using various current signals. The various current signals provide for different rotational pulses of the electric motor 180, whereby the current signals are directed to the electric motor 180 via a control line. The power source can, e.g., be designed as a battery or, as in the illustrated exemplary embodiment, as a battery pack 190 or as a grid connection.

Furthermore, controls (not shown in detail) can be provided in order to adjust various modes of operation and/or the direction of rotation of the electric motor 180.

A solution to the problem described hereinabove will be described hereinafter, i.e. that, when fastening elements are tightened with interchangeable nuts for hex heads or with tool bits, the nut or bit can become jammed on or in the drive of the fastening element, or the nut or bit can become jammed on the interface of the hand-held power tool 100 for receiving the accessory. This issue is quite common due to the high torques needed to tighten a screw connection and the pulse-like load from the impact operation in the case that the hand-held power tool 100 is a rotary impact wrench.

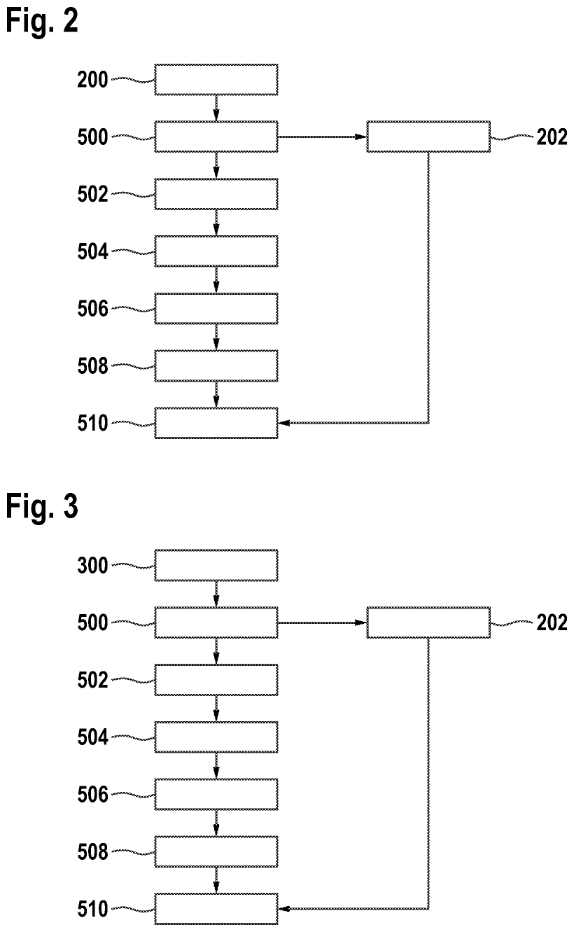

FIG. 2 shows a flowchart of an exemplary embodiment of the method according to the disclosure. The method shown in the drawing relates to a hand-held power tool 100, in which, e.g., an operating mode selector switch or mode switch can be used to select an operating mode, in which the hand-held power tool 100 ends a screwing operation after a predefined time period after the onset of a rotary impact operation and/or after a predefined number of impacts of the rotary impact operation and automatically releases potential jamming. The details of this method are explained hereinafter.

In 200, a user selects the operating mode described above, in which the hand-held power tool 100 automatically ends the screw-in operation after a predefined time period following the onset of a rotary impact operation and/or after a predefined number of impacts of the rotary impact operation and automatically releases potential jamming.

In 500, the user actuates the user switch 195 of the hand-held power tool 100, thereby starting the electric motor 180 at 502. The tool holder, and thus the fastening element, rotates in a first direction of rotation. In the case of conventional fastening elements with a right-hand thread, the first direction of rotation is clockwise rotation, whereby the reference point is taken as the perspective of the user looking at the fastening element to be screwed. For fastening elements with a left-hand thread, the first direction of rotation is counterclockwise.

Screwing the fastening element into a substrate, while rotating the tool holder, and thus the fastening element, in the first rotational direction, is referred to as step S1 in the context of the present disclosure.

If the user releases the user switch 195 at 202 at any point prior to the end of the routine, the controller 370 stops the electric motor 180 at 510 and the method is ended.

In embodiments of the disclosure, the screwing of the fastening element in step S1 is performed at least partially using a rotary impact operation, the onset of which is dependent on a level of torque applied to the tool holder. When a certain torque is exceeded, the rotary impact wrench usually starts rotary impact operation automatically, but this is typically not necessarily achieved by a purely mechanical coupling, i.e., it is not specified by the controller 370. In the embodiment in FIG. 2, the controller 370 of the hand-held power tool 100, detects the onset of the rotary impact operation at 504.

It will be discussed in more detail later on how the controller detects the onset of the rotary impact operation. In summary, it can be said that detecting the rotary impact operation and/or screwing operation without impact is performed at least partially on the basis of a signal waveform of an operating variable of the electric motor 180 of the hand-held power tool 100.

In this case, a comparison of a curve of the signal waveform of the operating variable of the electric motor 180 with a model signal waveform can be performed.

Further in the flowchart of FIG. 2, the tool holder is initially stopped after the predefined time period has elapsed after detecting the rotary impact operation and/or after the predefined number of impacts of the rotary impact operation at 506.

During the performance of step S1, jamming of the tool could have occurred in the tool holder and/or the drive of the fastening element with the tool. This is particularly likely if, in step S1, as is the case in the embodiment described in FIG. 2, a rotary impact operation is performed, which is associated with high pulse-like loads on the interfaces between the tool, tool holder, and drive of the fastening element. The jamming may have been completely unnoticed by the user in step S1.

To release potential jamming, the tool holder is now rotated at 508 in a second direction of rotation opposite the first direction of rotation, which is referred to as step S2 in the context of the present disclosure. Step S2 comprises rotating the tool holder in a second direction of rotation opposite the first direction of rotation, at a predefined speed, and for a predefined time period.

By rotating in the second direction of rotation, the fastening element is slightly loosened again, for which a release torque between the fastening element and the screw support must be built up. This release torque is transmitted in the interfaces between the drive of the fastening element, tool and tool holder, and acts in the opposite direction to the torque that caused or facilitated jamming. Jamming can thereby be released in step S2.

The rotation in the second direction of rotation is performed using predefined parameters, for example with respect to rotational speed or torque, which in embodiments of the disclosure may be different from the parameters selected by the user at the start of screwing the fastening element in step S1.

As previously described hereinabove, the rotation of the tool holder in the second direction of rotation opposite to the first direction of rotation in step S2 takes place at a predefined speed and over a predefined time period such that jamming of the tool in the tool holder and/or the drive of the fastening element with the tool is released, but without the screw connection being loosened. There is no or only a negligible reduction in the release torque required to loosen the screw connection.

In embodiments of the disclosure, during the transition from the first to the second direction of rotation between step S1 and step S2, a run-up ramp is passed through in order to keep loads on the fastening element, the hand-held power tool 100 and the user low, and to prevent the tool from slipping off the fastening element. It can also be provided that the stoppage of the electric motor 180 described at 506 is more or less pronounced, up to the case where virtually smooth transitions between the direction of rotations are implemented and a stoppage is therefore not present.

After the predefined time period has elapsed during which the tool holder rotates in the second direction of rotation in step S2, the controller 370 stops the electric motor 180 at 510 and the method is ended.

FIG. 3 shows a flowchart of a further exemplary embodiment of the method according to the disclosure. The method shown in the drawing relates to a hand-held power tool 100, in which, e.g., an operating mode selector switch or mode switch can be used to select an operating mode, in which the hand-held power tool 100 automatically releases potential jamming.

In 300, the user selects the operating mode described above in which the hand-held power tool 100 automatically releases potential jamming. 500, 202, and 502 to 510, as shown in FIG. 3, are identical to the steps described with the same reference characters in connection with FIG. 2.

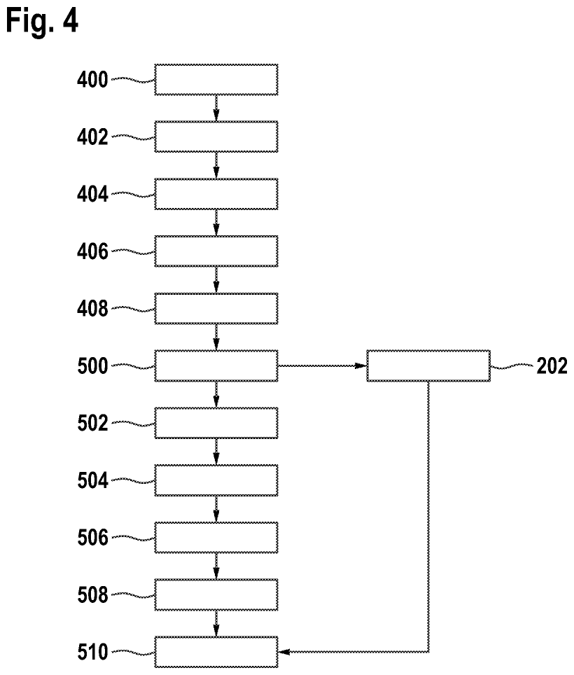

FIG. 4 shows a flowchart of a further exemplary embodiment of the method according to the disclosure. The method shown in the drawing relates to a hand-held power tool 100 in which the operating mode, in which the hand-held power tool 100 automatically releases potential jamming, is selected via a software application (app).

In step 400, the user launches the app on an external device, such as a tablet or smartphone, and selects at 402 the operating mode in which the hand-held power tool 100 automatically ends the screwing operation after a predefined time period after the onset of a rotary impact operation and/or after a predefined number of impacts of the rotary impact operation.

In 404, the user selects the operating mode in which potentially jamming is automatically released. In 406, the user can enter further parameters in this regard to ensure that the method causes jamming to be released, but at the same time does not loosen the screw connection by reversing the direction of rotation in step S2. Such parameters include, for example, the diameter and type of fastening element (e.g., self-tapping screw, concrete screw, metric thread screw, to name but a few), the screw class, and/or the bit type to be used. In one embodiment of the method, the user scans a barcode on the package, for example with a camera function associated with the app, whereby the app identifies the parameters itself, for example via an Internet connection, loads them and assigns them in the operating mode.

In 408, this operating mode selected in the app and optionally further defined by parameters is transmitted to the controller 370 of the hand-held power tool 100 via a suitable connection. The controller 370 activates the operating mode thereafter for execution by the hand-held power tool 100.

The further steps 500, 202, and 502 to 510 shown in FIG. 4 are identical to the steps described with the same reference characters in connection with FIG. 2.

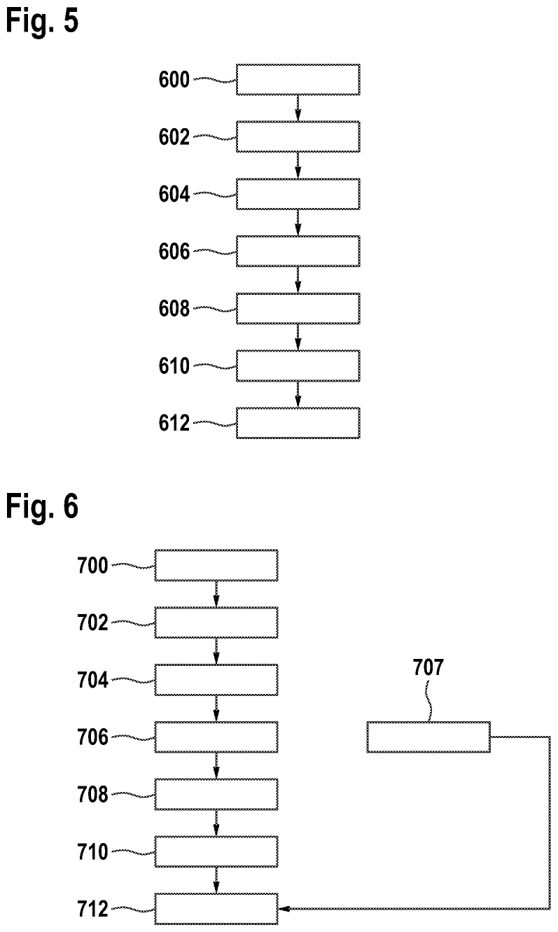

FIG. 5 shows a flowchart of a further exemplary embodiment of the method according to the disclosure. The method shown in the drawing relates to a hand-held power tool 100 in which the operating mode, in which the hand-held power tool 100 releases potential jamming, is selected by the user, as needed, via a separate button on the hand-held power tool 100.

In 600, the user actuates the user switch 195 of the hand-held power tool 100, thereby starting the electric motor 180 at 602. In step S1, the tool holder and thus the fastening element rotates in the first direction of rotation to tighten the fastening element, with the screw parameters set in each case as necessary. The screwing process in step S1 is optionally performed at least partially using a rotary impact operation.

After completing the screw connection, the user detects jamming at 606. This occurs when, e.g., the user wants to release the hand-held power tool 100 from the fastening element, but jamming prevents the hand-held power tool 100 from being lifted in a conventional smooth manner.

To release potential jamming, the user then presses a button on the hand-held power tool 100 separate from the user switch 195 at 608. In 610, this causes the tool holder to be rotated at a predefined speed and for a predefined time period in the second direction of rotation opposite the first direction of rotation, which is referred to as step S2 in the context of the present disclosure. As previously described hereinabove, the jam is thereby released. The controller 370 stops the method at 612 by stopping the motor 180.

FIG. 6 shows a flowchart of a further exemplary embodiment of the method according to the disclosure. The method shown in the drawing relates to a hand-held power tool 100 in which the hand-held power tool 100 automatically detects jamming. This can, e.g., be performed using suitable sensors arranged on the hand-held power tool 100 or by evaluating operating parameters detected by the hand-held power tool 100.

In 200, a user selects the operation mode described above, in which the hand-held power tool 100 automatically ends the screw-in operation after a predefined time period after the onset of a rotary impact operation and/or after a predefined number of impacts of the rotary impact operation and automatically releases potential jamming if it has been detected by the motor controller 370.

In 700, the user actuates the user switch 195 of the hand-held power tool 100, thereby starting the electric motor 180 at 702. As in the embodiments described hereinabove, in step S1 the tool holder and thus the fastening element rotates in the first direction of rotation to tighten the fastening element, with the screw parameters set in each case as necessary.

The screwing of the fastening element in step S1 is performed at least partially during the execution of the rotary impact operation, the onset of which the controller 370 of the hand-held power tool 100 detects at 704.

In 706, the user or controller 370 stops further screwing of the fastening means as planned. Alternatively, this is done by the user considering the screwing operation to be complete and releasing the user switch 195, or by the controller 370 stopping the tool holder after a predefined time period has elapsed after the rotary impact operation has been detected and/or after a predefined number of impacts.

During the screwing process and in embodiments also thereafter, the controller 370 monitors whether jamming is present, which is referred to as step S1a in the context of the present disclosure.

If the controller 370 has not detected jamming at 707, the method ends at 712.

If the controller 370 detects jamming at 708 based on the operating parameters recorded during the screwing operation or by evaluating sensor data recorded during the screwing operation, the tool holder is rotated at 710 in step S2 in the second direction of rotation opposite the first direction of rotation, at a predefined speed and for a predefined time period. The jam is thereby released as described above.

After the predefined time period has elapsed during which the tool holder rotates in the second direction of rotation in step S2, the controller 370 stops the electric motor 180 at 712 and the method is ended.

The following describes a method by means of which the controller can determine whether there is a rotary impact operation or a screwing operation without impact. Alternative options for such detection are also applicable in the method according to the disclosure.

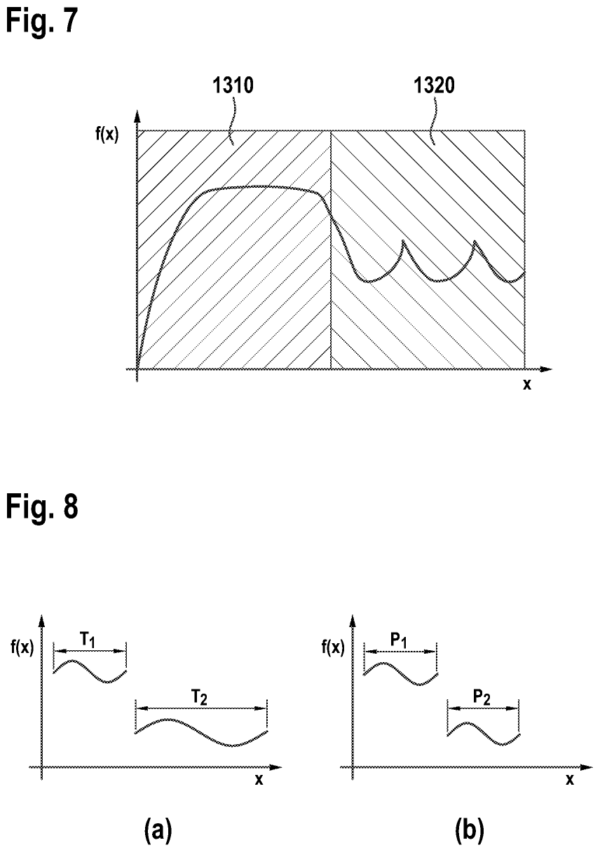

FIG. 7 shows a signal 1400 of an operating variable of the electric motor 180 of the hand-held power tool 100, as it occurs in the same or a similar form when using the hand-held power tool 100 as intended.

Time is plotted on the ordinate x in the present example of FIG. 7, but in alternative embodiments an alternative variable, e.g. the motor rotational angle, is also selected as the reference value. On the abscissa f(x) in the drawing, the motor speed n present at each chronological point is plotted. Instead of the motor speed, another operating variable correlating to the motor speed can also be selected. In alternative embodiments of the disclosure, f(x) represents, e.g., a signal of motor current.

Motor speed and motor current are operating variables that are typically detected by the controller 370 on hand-held power tools 100, without any additional effort. Recording the signal of an operating variable of the electric motor 180 is further referred to as step A2. In preferred embodiments of the disclosure, a user of the hand-held power tool 100 can select on the basis of which operating variable the disclosed method is to be performed.

It can be seen in FIG. 7 that the signal comprises a first region 1310 characterized by a monotonous increase in motor speed, as well as a region of comparatively constant motor speed, which can also be referred to as a plateau. The intersection point between ordinate x and abscissa f(x) in FIG. 7 corresponds to the start of hand-held power tool 100 during the screwing operation.

In the first area 1310, the hand-held power tool 100 operates in the operating state of the screw without impact.

In a second area 1320, the hand-held power tool 100 operates in rotary impact operation. The rotary impact operation is characterized by an oscillating course of the operating signal, whereby the shape of the oscillation can be trigonometric, for example sinusoidal, or otherwise oscillating. In the present case, the oscillation has a course which can be referred to as a modified trigonometric function, whereby the upper half-wave of the oscillation has a pointed hat or tooth-like shape. This characteristic shape of the operating signal in rotary impact operation results from the drawing up and free-running of the impact mechanism striker and the system chain located between the impact mechanism and the electric motor 180, among others, of the transmission 170.

The qualitative signal waveform of the impact operation is thus generally known due to the inherent characteristics of the hand-held power tool. In embodiments of the method according to the disclosure, at least one state-typical model signal waveform is determined in a step A1 on the basis of this knowledge, whereby the state-typical model signal waveform is associated with a first operating state, in the example of FIG. 7 thus the rotary impact operation in the second region 1320. In other words, the state-typical model signal waveform contains typical characteristics for the first operating state such as the presence of a vibration curve, vibration frequencies or amplitudes, or individual signal sequences in continuous, quasi-continuous, or discrete form.

In other applications, the first operating state to be detected can be characterized by other signal waveforms than vibrations, such as by discontinuities or growth rates in the function f(x). In such cases, the state-typical model signal waveform is characterized by precisely these parameters, rather than vibrations.

In embodiments of the disclosure, the operating state to be detected is the rotary impact operation. According to the method, it can be provided that in the absence of detection of the operating state to be detected, it is concluded that there is a specific other operating state, for example, screwing without impact or jamming of the nut or the bit on or in the drive of the fastening element or on the interface of the device for receiving the accessory, e.g. a nuts or bit. Two or more first operating states can also be defined, the occurrence of which is monitored, e.g. the rotary impact operation, the screwing operation without impact, and jamming.

In a preferred embodiment of the disclosed method, in step A1 the state-typical model signal waveform can be defined by the user, e.g. by selecting different pre-set signal waveforms or signal characteristics. In other embodiments, the state-typical model signal waveform is permanently stored by the manufacturer of the hand-held power tool 100 before it is delivered and is thereby determined.

In step A3 of the method according to the disclosure, the signal of the operating variable of the electric motor 180 is compared to the state-typical model signal waveform. The “comparing” feature is intended to be interpreted broadly and in the sense of a signal analysis in the context of the present disclosure, so that a result of the comparison can in particular also be a partial or gradual match of the signal of the operating variable 1400 of the electric motor 180 to the state-typical model signal waveform, whereby the degree of matching of the two signals can be ascertained by various methods, which will be specified hereinafter.

In a step A4 of the method according to the disclosure, the decision as to whether the first operating state is present is made at least in part on the basis of the result of the comparison. In this case, the degree of matching is a parameter that can be set by the factory or user for adjusting a sensitivity of detection of the first operating state.

In practical applications, it can be provided that steps A2, A3, and A4 are performed repeatedly during operation of the hand-held power tool 100 to monitor operation for the presence of the first operating state. For this purpose, in step A2, the recorded signal of the operating variable 1400 can be sequenced, so that the steps A3 and A4 are performed on signal sequences, preferably always of the same defined length.

For this purpose, the signal of the operating variable can be stored in a memory, preferably a ring memory, of a rotary impact wrench 100 as a result of measured values.

As already mentioned in connection with FIG. 7, in preferred embodiments of the disclosure, in step A2, the signal of the operating variable is recorded as a chronological course of measured values of the operating variable, or as measured values of the operating variable over a rotational angle of the electric motor 180. The measured values can be discrete, quasi-continuous, or continuous.

A particularly preferable embodiment provides for the signal of the operating variable to be recorded in step A2 as a chronological curve of measured values of the operating variable, and, in a step A2a, for the chronological curve of the measured values of the operating variable to be transformed into a curve of the measured values of the operating variable over a rotational angle of the electric motor.

The advantages of this embodiment will be described hereinafter with reference to FIG. 8. Similar to FIG. 7, FIG. 8a shows signals f(x) of an operating variable over an ordinate x, in this case over time t. As in FIG. 7, the operating variable can be a motor speed or a parameter correlating to the motor speed.

The drawing includes two signal profiles of the operating variable in the first operating mode, i.e., in rotary impact operation in the case of a rotary impact wrench. In both cases, the signal comprises a wavelength of an idealized vibration curve assumed to be sinusoidal, whereby the shorter wavelength signal, T1, has a curve with higher impact frequency and the longer wavelength signal, T2, has a curve with a lower impact frequency.

Both signals can be generated using the same hand-held power tool 100 at different motor speeds and are dependent on, among other things, which revolution speed the user requests from the hand-held power tool 100 via the operating switch.

If, for example, the “wavelength” parameter is then intended to be used in order to define the state-typical model signal, at least two different wavelengths T1 and T2 would have to be stored as possible parts of the state-typical model signal for the present case, so that the comparison of the signal of the operating variable 1400 with the state-typical model signal waveform in both cases leads to the result of “match”. Given that the motor speed can change generally and to a large extent over time, this also causes the wavelength sought to vary, thereby requiring the methods for detecting this impact frequency to be adjusted in an adaptive manner accordingly.

With a plurality of possible wavelengths, the effort of the method and programming would increase accordingly.

Therefore, the chronological values of the ordinates are in this preferred embodiment transformed into rotational angle values of the electric motor 180. This is possible because the rigid gear ratio of the electric motor to the impact mechanism results in a direct, known dependence of motor speed on the impact frequency. This normalization achieves a vibration signal of consistent periodicity independent of the motor speed, which is shown in FIG. 8b by the two signals belonging to T1 and T2, whereby both signals now have the same wavelength P1=P2.

Accordingly, in this embodiment of the disclosure, the state-typical model signal valid for all speeds can be determined by a single parameter of the wavelength via the motor rotational angle.

In one preferred embodiment, the comparison of the signal of the operating variable 1400 with the state-typical model signal is performed using one of the comparison methods comprising band pass filtering, frequency analysis, parameter estimation, and/or cross-correlation, which is described in more detail hereinafter.

In embodiments having band pass filtering, the input signal, optionally transformed to rotation angle dependence as described, is filtered via a band pass whose passband matches a frequency defined in connection with the state-typical model signal. In the event that amplitudes of this frequency exceed a specified limit value, as is the case in the first operating state, the comparison in step A3 then results in the outcome that the signal of the operating variable is the same as the state-typical model signal waveform and that the first operating state is performed. Determining an amplitude limit value can be considered in this embodiment as step A3a of a quality determination of the match of the state-typical model signal waveform with the signal of the operating variable, on the basis of which it is decided whether the first operating state is present or not in step S4.

In embodiments which use frequency analysis as the comparison method, the signal of the operating variable is transformed from a chronological range into the frequency range with corresponding weighting of the frequencies based on the frequency analysis, e.g. a Fast Fourier Transformation (FFT), whereby at this point the term “chronological range” is to be understood both as “course of operation variable over time” and a “course of the operating variable over the motor rotational angle” in accordance with the explanations hereinabove.

Methods other than the method for automatically detecting a rotary impact operation described above with reference to FIGS. 7 and 8, can be applied in the context of the disclosure to automatically detect during step S1 whether there is a rotary impact operation or a screwing operation without impact, and whether jamming has occurred. For example, sensors, e.g. accelerometers, can be provided for these purposes.

The disclosure is not limited to the exemplary embodiment described and illustrated. Rather, the disclosure also comprises all embodiments by a skilled person within the scope of the disclosure.

In addition to the described and illustrated embodiments, further embodiments are conceivable, which can comprise further modifications as well as combinations of features.

What is claimed is:

1. A method for operating a rotary impact wrench, the hand-held power tool comprising a tool holder configured to receive a tool such as a tool bit or a nut, wherein the tool is configured to rotatably drive the fastening element via a corresponding drive of a fastening element, said method comprising:
screwing the fastening element into a substrate while rotating the tool holder, and thus the fastening element, in a first direction of rotation; and
rotating the tool holder in a second direction of rotation opposite the first direction of rotation at a predefined speed and for a predefined time period.

2. The method according to claim 1, further comprising:
monitoring to determine that jamming occurs during or after the screwing process, wherein jamming occurs when the tool is jammed in the tool holder and/or when the drive of the fastening element and the tool are jammed together.

3. The method according to claim 2, wherein the monitoring is performed during the screwing of the fastening element in the first direction of rotation by a user of the hand-held power tool, or is performed at least partially automatically.

4. The method according to claim 3, wherein the rotating the tool holder in the second direction of rotation is initiated by the user actuating a control button separate from an on/off switch of the hand-held power tool.

5. The method according to claim 2, wherein the rotating the tool holder in the second direction of rotation is performed in response to determining that jamming has occurred.

6. The method according to claim 1, wherein the screwing the fastening element in the first direction of rotation takes place at least partially using a rotary impact operation.

7. The method according to claim 6, further comprising:
automatically detecting the rotary impact operation.

8. The method according to claim 7, wherein the rotating the tool holder in the second direction of rotation is performed after a predefined time period after detecting the rotary impact operation and/or after a predefined number of impacts of the rotary impact operation.

9. The method according to claim 7, wherein the automatic detection is performed at least partially on the basis of a signal waveform of an operating variable of an electric motor of the hand-held power tool.

10. The method according to claim 1, wherein:
the screwing the fastening element in the first direction of rotation is triggered by actuating an operation button of the hand-held power tool; and
a release of the operation button cancels and/or ends the method.

11. The method according to claim 1, wherein the method is started or initialized via a software application (app), wherein the app is executed on a device that is separate from the hand-held power tool.

12. The method according to claim 11, wherein:
the method provides a screw connection;
parameters of the screw connection are adjustable via the app; and
the parameters comprise at least one of the following parameters:
a diameter and/or type of fastening element;
a material, strength, and/or hardness of the substrate; and
a predefined speed and/or predefined time period for the rotating the tool holder in the second direction of rotation.

13. The method according to claim 1, wherein the method is started or initialized by actuating a control button located on the hand-held power tool.

14. The method according to claim 1, wherein the predefined speed and the predefined time period in the rotating the tool holder in the second direction of rotation are predefined such that jamming of the tool in the tool holder and/or the drive of the fastening element comprising the tool is released, but without the screw connection being loosened.

15. A computer program for performing the method according to claim 1 when the computer program is executed by a controller of a hand-held power tool.

16. A hand-held rotary impact wrench, comprising:
an electric motor;
a rotary-driven tool holder configured to receive a tool; and
a controller configured to control the electric motor,
wherein the controller is configured to perform the method according to claim 1.
